(19) United States
(12) Patent Application Publication
(10) Pub. No.: US 2008/0011432 A1
(43) Pub. Date: Jan. 17, 2008

(54) High-speed door

(75) Inventor: Manfred SEYSEN, Graefelfing (DE)

Correspondence Address: SUGHRUE MION, PLLC, 2100 PENNSYLVANIA AVENUE, N.W., SUITE 800, WASHINGTON, DC, 20037, US

(73) Assignee: Manfred SEYSEN, Grafelfing (DE)

(21) Appl. No.: 11/737,771

(22) Filed: Apr. 20, 2007

(30) Foreign Application Priority Data
Apr. 21, 2006 (DE) 102006018637.0-42

(51) Int. Cl. E06B 9/56

(52) U.S. Cl. 160/309

(57) ABSTRACT

Door, in particular a high-speed door, comprising at least one door leaf made of a flexible material and a door drive for moving the door leaf between an open position and a closed position. The door leaf and the door drive may be coupled to one another via a fastening device which extends over the width of the door leaf, at least in places, along an upper edge of the door leaf in the closed position to form a rotatable winding axis in the shape of an open cylindrical shell.

The present invention relates to a door which in particular is designed as a high-speed door, wherein high-speed doors are understood to mean doors having an opening or closing speed of approximately 1.0 to 3.5 m/s.

The high-speed doors known from the prior art essentially comprise a door leaf which covers a door opening and which is referred to as a hanging. For opening the door, this hanging is wound onto a shaft or a cylinder made of metal or plastic. A problem with such doors is that when transparent material such as PVC, for example, is used, these doors lose their transparency due to the friction on the individual windings so that vision through the material, necessary for accident prevention, is not maintained. In addition, such doors tend to lose their strength as the result of constant repeated winding or the elevated temperatures of approximately 30° C. and greater, so that over time the doors become too weak to withstand wind pressure.

The object of the present invention, therefore, is to provide a door, in particular a high-speed door, in which the door leaf has sufficient strength to withstand wind pressure, and in which transparency is maintained upon repeated winding.

This object is achieved by a door, in particular a high-speed door, having the features of claim 1. Preferred embodiments result from the dependent subclaims.

According to the invention a door, in particular a high-speed door, is provided which comprises at least one door leaf made of a flexible material, and a door drive for moving the door leaf between an open position and a closed position, whereby the door leaf and the door drive may be connected to one another via a fastening device which extends over the width of the door leaf, at least in places, along an upper edge of the door leaf in the closed position to form a rotatable winding axis in the shape of an open cylindrical shell.

The door is advantageously designed as a high-speed door which moves the door leaf between the open and closed positions at a speed of approximately 1.0 to 3.5 m/s, preferably 1.8 to 3.5 m/s. The door advantageously has a single door leaf which in the closed position covers the door opening enclosed by the door frame. However, a number of door leaves connected to one another in an articulated manner may also be provided. The door leaf is preferably made of a flexible material. In other words, the door leaf may be provided as a thin sheet or film having a flexible design. In this context, “flexible” means that the material is pliant so as to allow winding of the door leaf, and is not understood as a change in the length or width of the selected material. The door has a door drive for moving the door leaf between the open and closed positions. This may be performed manually, but as a rule the door is actuated electrically by use of a motor. To transfer the drive from the door drive to the door leaf a fastening device is provided via which the door drive is directly or indirectly coupled to the door leaf. The fastening device is advantageously provided at an upper edge of the door leaf, and advantageously extends over the entire width of the door leaf, at least in places. In other words, a fastening device is provided in the region of the upper lintel of the door, i.e., for a door leaf in the closed position, at the upper edge or wide side of the door leaf which extends essentially horizontally. The fastening device is rotatable about a winding axis.

Consequently, the fastening device is not coaxial with the winding axis, but instead rotates about the winding axis. The winding axis essentially corresponds to the rotational axis of the cylinder or tubular element which is formed by the door leaf during the winding. In other words, the door leaf is wound around the winding axis. The fastening device has the shape of an open cylindrical shell. In other words, the fastening device does not form a closed cylinder as such, but, rather, forms only a portion of a cylindrical shell which is not closed at any location. Thus, the cross section of the fastening device forms a section of a circular arc, or any given curved section. When the door leaf is wound up, i.e., is in the open position, it thus forms an essentially cylindrical element which encloses the fastening device. Alternatively, the fastening device may also have a solid design, thus forming a cylindrical segment of a solid cylinder.

The door leaf in the open position preferably forms a dimensionally stable, self-supporting, tubular element. In the open position the door leaf is essentially wound up, so that it has a spiral-shaped cross-sectional configuration. A geometric configuration is thus obtained which results in a roller or a tubular element that is rigid and nondeformable. Thus, the tubular element, i.e., the door leaf, supports itself in the open position without the need for a supporting function by the fastening device. The self-supporting characteristic is assisted by selection of a suitable material, a flexible material having little or no elasticity being particularly suited.

The fastening device preferably has at least one clamping device for affixing the door leaf thereto, the clamping device preferably extending essentially over the entire width of the door leaf. It is understood that instead of or in addition to the clamping device any other given fastening device may be provided, such as by gluing, welding, or attachment via mechanical fastening means, such as screws or rivets that penetrate the door leaf.

In one preferred embodiment, the fastening device has an imbalance compensation device, preferably in the form of a counterweight, situated essentially radially opposite with respect to the winding axis. In other words, the imbalance compensation device is radially displaced essentially by 180° in relation to the fastening device, thereby ensuring that the fastening device runs concentrically about the winding axis.

It is advantageous for the radial distance of the imbalance compensation device from the winding axis to be adjustable by means of an adjustment device. The adjustment device may, for example, have the design of a threaded bolt which extends radially from the winding axis and to which at the distal, i.e., free, end thereof the imbalance compensation device is fixed in such a way that the distance from the latter to the winding axis may be adjusted via the thread.

The door also preferably has spacing means designed such that a distance is provided between the individual windings of the door leaf in the open position. It is understood that for a door in an intermediate position between the open and closed positions, at least the region that is already wound is spaced by the spacing means. Thus, a door may advantageously be provided for which the windings of the door leaf do not touch in the open position of the door leaf, thereby preventing abrasion or scratching due to contact with the individual windings of the door leaf.

The spacing means are advantageously designed in the form of at least one belt or band which in the open position is situated between the individual windings of the door leaf. The belt or band thus acts as a spacer between the individual windings of the door leaf, so that in the open position, i.e., in the wound state, the windings of the door leaf do not contact one another. This is facilitated in particular by the material of the door leaf, which advantageously has an essentially rigid design, so that even in regions between the spacing means along the wide side of the wound door leaf the windings of the door leaf do not rest one on top of the other.

The spacing means are preferably designed in the form of at least two belts or bands, which in the open position are situated between the individual windings of the door leaf essentially on the distal broad sides of the door leaf.

It is practical for the belt to be windable on at least one winding device situated essentially on the distal broad side of the door leaf. For a door leaf that is wound up, i.e., in the open position, the winding device is essentially enclosed by the wound door leaf, whereby a layer of the belt is provided between the winding device and the first winding of the door leaf, and further winding of the door leaf results in an alternating sequence of belt and door leaf on account of the spiral winding of the belt and door leaf.

The winding device is advantageously designed as a cylinder with a spiral-shaped cross section having a pitch corresponding to the thickness of the belt. Thus, when the door leaf is wound a bulge which could result in imbalance is advantageously avoided, since the spiral pitch corresponds to the belt thickness at a distance of a circumferential angle of 360° (i.e., the distance corresponding to the circumference). Gradation at the installation site at which the belt is fastened to the winding device is thus avoided, resulting in an essentially circular cross-sectional shape of the winding device provided with the belt. This advantageously results in smooth, balanced operation which allows door opening speeds of greater than 2 m/s.

The thickness of the belt advantageously corresponds at least to the height of the clamping device, thereby also avoiding bulging and imbalance caused by the clamping device.

The belt is advantageously made of a textile material, and preferably has one or more sections that are resilient at least in places. The resilient sections are practical in order to compensate for a change in length occurring during winding and unwinding as the result of the differing material thicknesses of the belt and door leaf. A resilient section is preferably provided in particular at the end of the belt that is not fastened to the winding device, but particularly preferably at a lower part of the door leaf.

Alternatively, the belt may be made entirely of a resilient material, preferably rubber.

In one further preferred embodiment, the spacing means are provided in the form of two cones situated on the distal broad sides of the door leaf, coaxial with the winding axis, and the door leaf has a trapezoidal base, so that the converging edges of the door leaf engage with the outer surfaces of the cones in the conversion to the open position. The axis of rotational symmetry of the cones essentially corresponds to the previously mentioned winding axis. Thus, the distance of the individual windings from the wound door leaf may be fixed by means of the pitch of the cones.

The cones preferably have a graduated spiral-shaped outer surface. This allows the door leaf to be wound so that each winding engages with its own gradation on the outer surface, and the individual windings of the door leaf are thus reliably separated from one another.

The door leaf advantageously is made of preferably transparent polycarbonate. In contrast to the door leaves from the prior art made of soft polyvinyl chloride, this material contains no externally diffusing softeners which deposit on the surface of the door leaf and which on account of their health hazards, particularly in sensitive areas such as the food industry, cannot be used. In addition, no static charge develops on the surface of the polycarbonate during winding and unwinding, so that deposition of dust particles from the ambient air onto the surface of the door leaf is avoided and the transparency of the door is maintained. Lastly, polycarbonate is heat-resistant so that the door leaf maintains its strength, even at temperatures of up to 90° C., and thus withstands wind pressure even under these extreme conditions.

Further advantages and features of the present invention result from the exemplary embodiment described below with reference to the figures, which show the following:

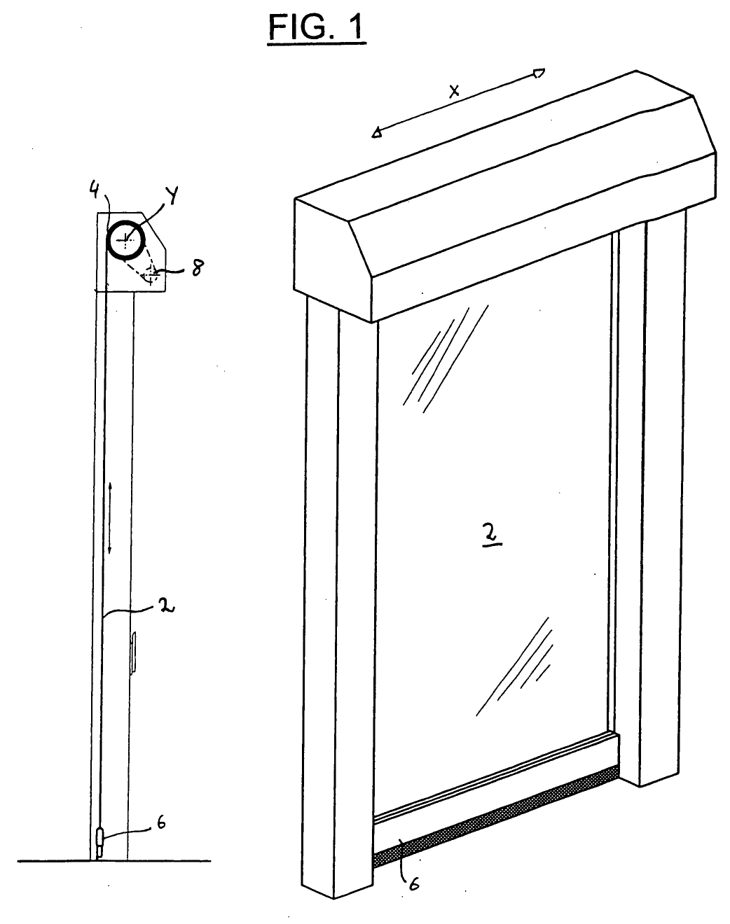

FIG. 1 shows a perspective view and a side view of one embodiment of the door according to the invention;

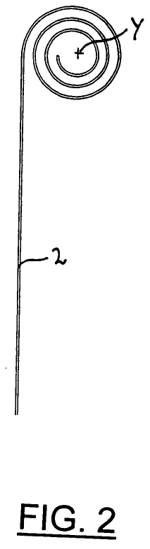

FIG. 2 shows a side view of a partially wound door leaf according to one embodiment of the door according to the invention;

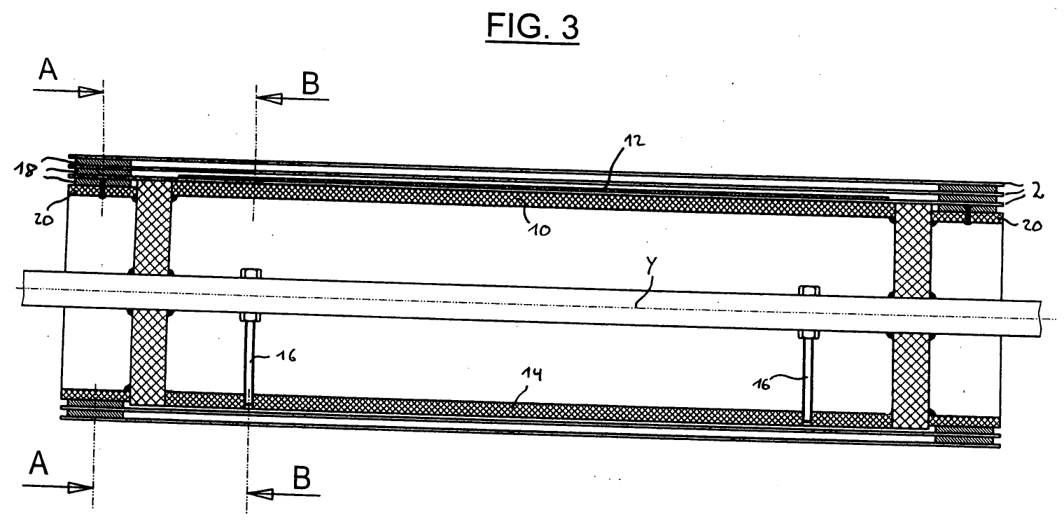

FIG. 3 shows a cross-sectional view of one embodiment of the door according to the invention in the wound state, i.e., in the open position of the door;

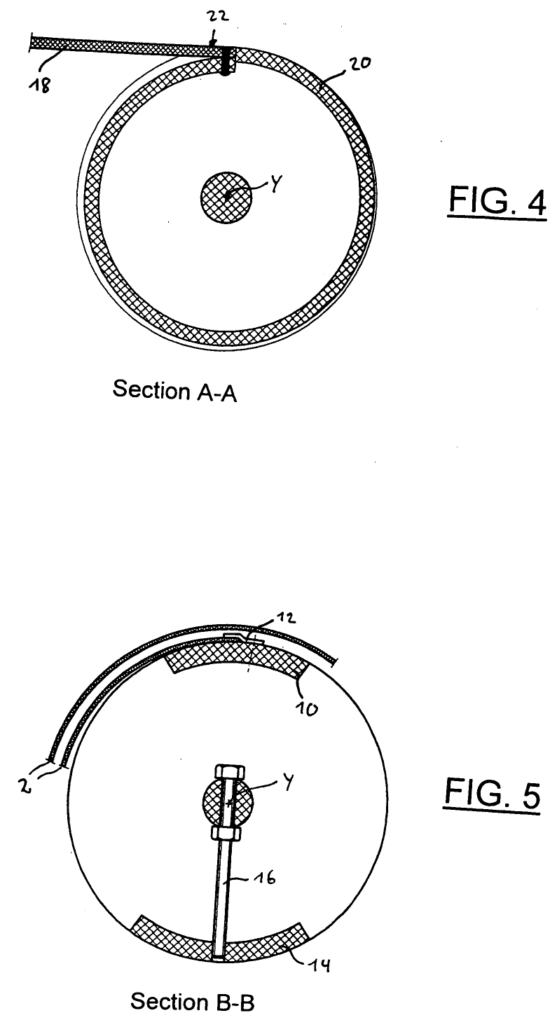

FIGS. 4 and 5 show cross-sectional views of the door according to the invention illustrated in FIG. 3;

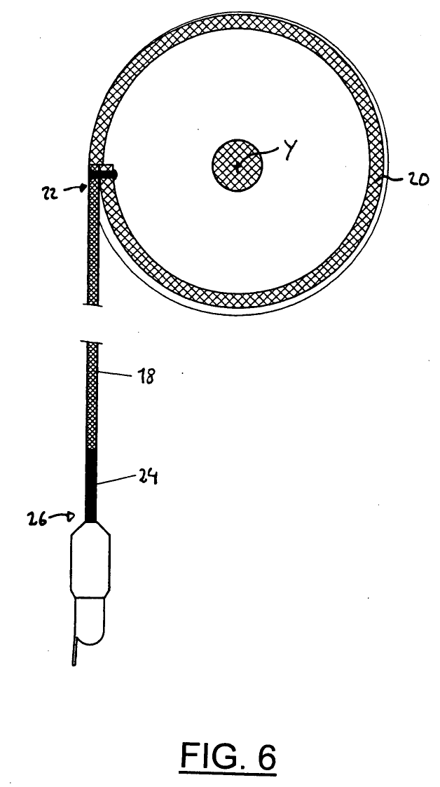

FIG. 6 shows a cross-sectional view of one embodiment of the door according to the invention; and

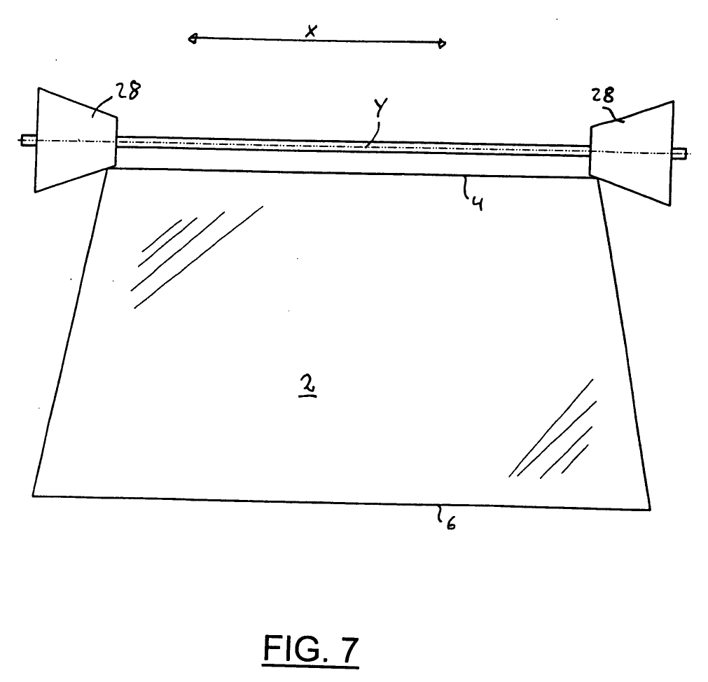

FIG. 7 shows an alternative embodiment of the door according to the invention.

The door according to the invention illustrated in FIG. 1 in one preferred embodiment comprises a door leaf 2 which is designed to cover a door or door opening in the closed position illustrated in FIG. 1. In the illustrated embodiment, the door leaf 2 completes a vertical motion upon opening or closing. It is understood that the door according to the invention may also be used in such a way that the door leaf 2 performs a horizontal motion during opening or closing. The door leaf 2 has an upper edge 4 and a lower edge 6. A door drive 8 is provided for moving the door leaf 2 between the open and closed positions. This may be performed manually, but preferably is performed via a motor drive. The door leaf 2 and door drive 8 may be coupled to one another via a fastening device 10 in such a way that the door leaf 2 is moved between the open and closed positions by actuation of the door drive 8.

The door leaf 2 is made of a flexible material which advantageously is transparent, at least in places, and which preferably has no elastic properties. A door leaf 2 is thus provided which in the closed position forms a dimensionally stable, self-supporting, tubular element as illustrated in FIG. 2. The winding of the door leaf 2 in particular results in a cylinder or roller having an essentially spiral-shaped cross-sectional configuration and which is rigid and/or nondeformable. It is therefore not necessary to wind the door leaf 2 on a cylinder or roller over the direction X of the width of the door leaf, as is customary in the prior art. Rather, it is sufficient to provide the fastening device 10 in such a way that the fastening device forms only a portion of a cylindrical outer surface in order to achieve adhesion between the door drive 8 and the door leaf 2. However, the fastening device 10 has no supporting characteristics over the direction X of the width of the door leaf, since in the wound state the door leaf 2 forms a self-supporting spiral.

FIG. 3 illustrates a cross section of the door according to the invention along the direction X of the width of the door leaf, in one preferred embodiment in the wound state, i.e., in the open position, whereas FIG. 4 shows a section along line A-A and FIG. 5 shows a section along line B-B. When the door leaf 2 is moved into the open position of the door, i.e., when the door leaf 2 is wound up, the door leaf 2 is wound around an essentially spiral-shaped winding axis Y. The fastening device 10 may also be rotated about the winding axis Y. The fastening device 10 has the shape of an open cylindrical outer surface which extends over the direction X of the width of the door leaf, at least in places. A clamping device 12 is provided on the fastening device 10 for attaching the upper edge 4 of the door leaf 2 to the fastening device 10. The clamping device 12 may extend essentially over the entire direction X of the width of the door leaf, as illustrated in FIG. 3. However, a number of individual clip-shaped clamping devices 12 may also be provided which are distributed over the direction X of the width of the door leaf. An imbalance compensation device 14 is provided essentially radially opposite from the fastening device 10 with respect to the winding axis Y. The imbalance compensation device 14 may be designed as a counterweight to ensure concentric operation about the winding axis Y. In one preferred embodiment an adjustment device 16 is provided by means of which the distance of the imbalance compensation device 14 from the winding axis Y may be adjusted. The adjustment device 16 is advantageously designed as a bolt, fastened to the winding axis Y, having a thread at least in the region of attachment to the imbalance compensation device 14 in order to variably fix the distance of the imbalance compensation device 14 from the winding axis Y.

To avoid the individual windings of the door leaf 2 from touching or making contact in at least the partially wound state, spacing means in the form of a belt 18 are advantageously provided. This belt 18 is situated essentially at the distal broad sides of the door leaf 2 such that the belt is provided between the individual windings of the door leaf 2. This results in an alternating sequence of the door leaf winding and the belt winding in the wound state of the door leaf 2. The thickness of the belt 18 advantageously is greater than the height of the clamping device, so that the clamping device 12 (FIG. 3) situated between the first and second winding of the door leaf 2 is not contacted by the second winding of the door leaf, thus avoiding imbalance due to bulging of the door leaf winding in this region and scratching of the door leaf. The belt advantageously is made of a textile material or rubber. A winding device 20 to which a first end 22 of the belt 18 is fastened is advantageously provided at the distal broad sides of the door leaf 2. The winding device 20 is used to wind the belt 18 and door leaf 2 in an alternating sequence. However, the winding device 20 does not impart stability to the door leaf 2 viewed in the direction X of the width of the door leaf; rather, in the open position the door leaf 2 is essentially self-supporting, as previously mentioned. To avoid bulging during the winding which could result in imbalance, the winding device 20 is designed as a cylinder having a spiral-shaped cross section (FIG. 4). The spiral of the winding device 20 has a pitch corresponding to the thickness of the belt 18 when the distance corresponds to one revolution of the winding device 20. Since the first end 22 of the belt 18 is situated at the gradation of the winding device, which corresponds to the thickness of a belt 18, when the belt 18 is wound onto the winding device 20 this results in an essentially uniformly constant pitch from the beginning of the winding process, without bulging which could adversely affect the synchronous operation.

The belt 18 advantageously is made of a textile material and has one or more resilient sections 24, at least in places. The resilient section 24 is provided in particular at the second end 26 of the belt 18 (FIG. 6). It is thus possible to compensate for the change in length caused by winding and unwinding, which results in particular from the differing thicknesses of the belt 18 and the door leaf 2. The second end 26 of the belt 18 is advantageously fastened to the lower edge 6 of the door leaf 2.

In an alternative embodiment illustrated in FIG. 7, the individual windings of the door leaf 2 may also be spaced by providing two cones 28. The cones 28 are aligned essentially coaxially with the winding axis Y, and are provided at the distal broad sides of the door leaf 2 with the tapered regions of the cones 28 facing one another. The door leaf 2 advantageously has a trapezoidal base. As a result, the converging edges of the door leaf 2 engage with or contact the outer surfaces of the cones 28 in the conversion to the open position. The door leaf 2 is spirally wound onto the cones 28 on account of the pitch thereof. The cones 28 may advantageously have a graduated, spiral-shaped outer surface to ensure even more precise spacing of the door leaf winding.

### LIST OF REFERENCE NUMERALS

2 Door leaf
4 Upper edge
6 Lower edge
8 Door drive
10 Fastening device
12 Clamping device
14 Imbalance compensation device
16 Adjustment device
18 Belt
20 Winding device
22 First end
24 Resilient section
26 Second end
28 Cone
X Direction of the width of the door leaf
Y Winding axis

1. A door, in particular a high-speed door, comprising
at least one door leaf made of a flexible material and a door drive for moving the door leaf between an open position and a closed position,
wherein the door leaf and the door drive may be coupled to one another via a fastening device, and
wherein the fastening device extends over the width of the door leaf, at least in places, along an upper edge of the door leaf in the closed position of the door leaf to form a rotatable winding axis (Y) in the shape of an open cylindrical shell.

2. The door according to claim 1, wherein the door leaf in the open position forms a dimensionally stable, self-supporting, tubular element.

3. The door according to claim 1, wherein the fastening device has at least one clamping device for affixing the door leaf thereto.

4. The door according to claim 1, wherein the fastening device has an imbalance compensation device, preferably in the form of a counterweight, situated essentially radially opposite with respect to the winding axis (Y).

5. The door according to claim 4, wherein the radial distance of the imbalance compensation device from the winding axis (Y) is adjustable by means of an adjustment device.

6. The door according to claim 1, also having spacing means designed such that a distance is provided between the individual windings of the door leaf in the open position.

7. The door according to claim 6, wherein the spacing means are designed in the form of at least one belt or band which in the open position is situated between the individual windings of the door leaf.

8. The door according to claim 6, wherein the spacing means are designed in the form of at least two belts or bands which in the open position are situated between the individual windings of the door leaf, essentially at the distal broad sides of the door leaf.

9. The door according to one of claims 7, wherein the belt may be wound onto at least one winding device which is situated essentially at the distal broad side of the door leaf.

10. The door according to claim 9, wherein the winding device is designed as a cylinder with a spiral-shaped cross section having a pitch corresponding to the thickness of the belt.

11. The door according to claim 7, wherein the thickness of the belt corresponds at least to the height of the clamping device.

12. The door according to claim 7, wherein the belt is made of a textile material and preferably has one or more sections that are resilient, at least in places.

13. The door according to claim 7, wherein the belt is made of a resilient material, preferably rubber.

14. The door according to claim 1, wherein the spacing means are provided in the form of two cones situated on the distal broad sides of the door leaf, coaxial with the winding axis (Y), and the door leaf has a trapezoidal base, so that the converging edges of the door leaf engage with the outer surfaces of the cones in the conversion to the open position.

15. The door according to claim 14, wherein the cones have a graduated spiral-shaped outer surface.

16. The door according to claim 1, wherein the door leaf is made of preferably transparent polycarbonate.

17. The door according to claim 3, wherein the clamping device extends essentially over the entire width of the door leaf.

18. The door according to claim 4, wherein the imbalance compensation device is in the form of a counterweight.

19. The door according to claim 13, wherein the resilient material is rubber.
